(19) United States
(12) Patent Application Publication
(10) Pub. No.: US 2024/0177580 A1
(43) Pub. Date: May 30, 2024

(54) DEVICE FOR CONVERTING THE WAVELENGTH OF LIGHT TO ASSIST A COLOR BLIND PERSON TO RECOGNIZE THE INTENDED COLOR

(71) Applicant: Lucent Medical Systems, Inc., Kirkland, WA (US)

(72) Inventors: Robert N Golden, Kirkland, WA (US); Fred E Silverstein, Friday Harbor, WA (US)

(21) Appl. No.: 18/521,695

(22) Filed: Nov. 28, 2023

Related U.S. Application Data
(60) Provisional application No. 63/428,667, filed on Nov. 29, 2022.

(51) Int. Cl. G08B 5/36; F21V 9/40; H02J 7/00

(52) U.S. Cl. CPC G08B 5/36; F21V 9/40; H02J 7/0047

(57) ABSTRACT

Described herein is a system and method to convert the photons of a first color of light emitted by a light source to photons of second color of light that is more easily distinguished from other colors by people with color blindness.

### BACKGROUND

### Technical Field

This disclosure relates to modifying the color viewed of a light indicator and in particular to converting the color output by an LED from a first color to a second color to assist color blind people in understanding the meaning of the indicator.

### Description of the Related Art

In the range of 7% to 8% of people have some form of color blindness and it is often genetic. Color blindness can vary from mild to severe. In the most severe cases, the individual has few or no cones in the retina of their eyes to sense one or more colors, such as green, red or blue. If the sensors for green are reduced or missing from the person's retina, the individual will not be able to distinguish green from red, both will look the same to them. Thus, people with various forms of red-green color blindness cannot easily tell what color the LED indicator is on battery chargers that use red during charging, and green when the battery is fully charged.

Many battery powered appliances today use red to indicate that the battery needs charging and green to indicate that the battery is fully charged.

### BRIEF SUMMARY

Therefore, there is a need in the art for a system and method to modify the color of the LED indicators in many electronic devices to colors more easily distinguishable by color blind individuals.

This disclosure describes a device and method to change the color of the LED indicators built into many electronic devices to colors more easily distinguishable by color blind individuals.

The device includes a photon wavelength converting material, either upconverting or downconverting, embedded in a carrier material. The converting material absorbs photons of a given wavelength and emits photons of a different wavelength, either shorter or longer. The converting material may be a dye, nanoparticle, combination of those, or another material which can receive photons of one wavelength and output photons of different wavelength. In a preferred embodiment, the converting material will absorb the photons of a first wavelength and emit new photons of a second wavelength.

The embedding material may be in the form of a tape, a polymer, or sheet. It can also be in the form of a lens, such as a converting plastic embedded in a holder having an adhesive that can hold and contain the upconverting means intact, attach it to the appliance and isolate it from environmental damage. In a preferred embodiment, it may have an adhesive layer allowing it to be removably attached over the indicator LED of interest.

In one embodiment, the system would consist of an adhesive tape roll, with an upconverting material optimized to convert the red or green wavelengths of common indicator LEDs to a yellow, blue or other wavelength. It might have two materials, one for upconverting red to yellow and another for upconverting the green wavelengths of common indicator LEDs to a blue wavelength, since yellow and blue wavelengths are more easily distinguishable by color blind individuals.

### BRIEF DESCRIPTION OF THE SEVERAL VIEWS OF THE DRAWINGS

FIG. 1A illustrates a battery charger having an LED indicator thereon.

FIG. 1B illustrates a color converting material overlying the battery charger of FIG. 1A.

FIG. 2A illustrates an electronic apparatus having an LED indicator thereon.

FIG. 2B illustrates a color converting material to be placed over the appliance of FIG. 2A.

FIG. 3A illustrates a power output appliance having LEDs.

FIG. 3B illustrates a color converting material being overlaid on the appliance of FIG. 3A.

FIG. 4 illustrates a color converting material in an adhesive.

FIG. 5 illustrates a color converting matrix material.

FIGS. 6A and 6B illustrate an active photon wavelength converter

FIG. 7 illustrates eyeglasses having photon wavelength converting material for the lenses.

### DETAILED DESCRIPTION

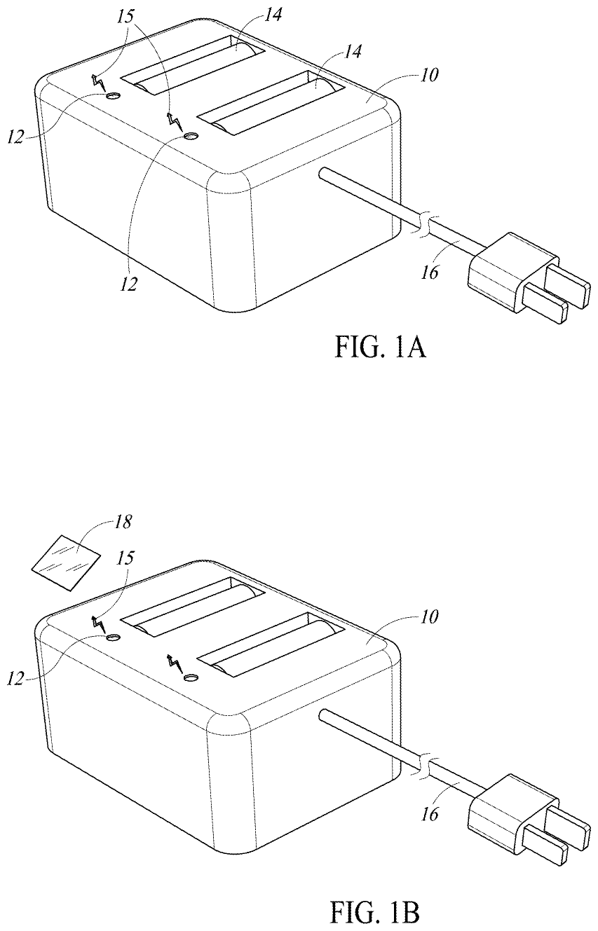

FIG. 1A illustrates a battery charger 10 having a light indicator 12 showing the charge state of batteries 14 being charged therein.

The battery charger 10 receives power via a cord 16 which can be input to an outlet connected to the grid or other source of power. The light indicator 12 outputs a color of light 15 appropriate to the charge state of the respective battery 14. If the batteries 14 are fully discharged and need charging, the output color will be red. During charging, the output may be a solid red, or may be a flashing red. As the batteries 14 approach full charge state, the light indicator 12 changes to green. It may be a solid green color, or a flashing green color depending on the type of indicator provided in the battery charger 10. The green color indicates that the respective battery 14 is fully charged and can be removed from the charger.

The battery 14 can be any type of battery, for example a lithium-ion battery, a smartphone battery, a nickel cadmium battery or any one of the numerous types of batteries which are capable of being recharged. The illustration of the cylindrical battery 14 in FIG. 1A is merely for case in understanding purposes and it is not necessarily a small round battery. It can take any form or shape and should be understood in FIG. 1A to be shown in schematic form.

In one embodiment, the light indicator 12 is of a type that has one lens and outputs different colors from the single lens of the light indicator 12. This can be provided by having different colored LEDs under the lens of the light indicator 12, a red LED and a green LED. The appropriate LED will turn on depending on the operation of the charger and the user will see either red or green from the single lens of the light indicator 12. Alternatively, a single LED can be provided which outputs a different color depending on the way it is driven.

If the viewer of the battery charger 10 has some type of colorblindness, they will not be able to distinguish whether the light indicator 12 is indicating a discharged battery 14 or a partially charged battery 14 or a fully charged battery 14. To a red-green color blind user, the light indicator 12 will be seen the same color, even though it's outputting a red or green or different color of light 15.

FIG. 1B illustrates a wavelength modifying material 18 which can be placed over the light indicator 12. The photon wavelength converting material, either upconverting or downconverting, can be a mesh that includes photon output compounds that are embedded in a carrier material. The converting material absorbs photons of a given wavelength and emits photons of a different wavelength, either shorter or longer. The converting material may include a dye, nanoparticle, a photon responsive compound, a fluorescent material, a combination thereof or another material which can receive photons of one wavelength and output photons of different wavelength. In a preferred embodiment, the converting material 18 will absorb the photons of a first wavelength and emit new photons of a second wavelength.

In the embodiment shown in FIG. 1B, only a single sheet of material 18 is shown over LEDs, however, one will be placed on top of each LED. In an alternative embodiment, when the battery charger has two LEDs each indicating a different battery charge state, the photon converting material 18 can be placed on just a single LED for use by the viewer who is colorblind, and the other LED can be used to indicate the battery state for a person who is not colorblind. Thus, the device can be easily be used by different individuals in the same household.

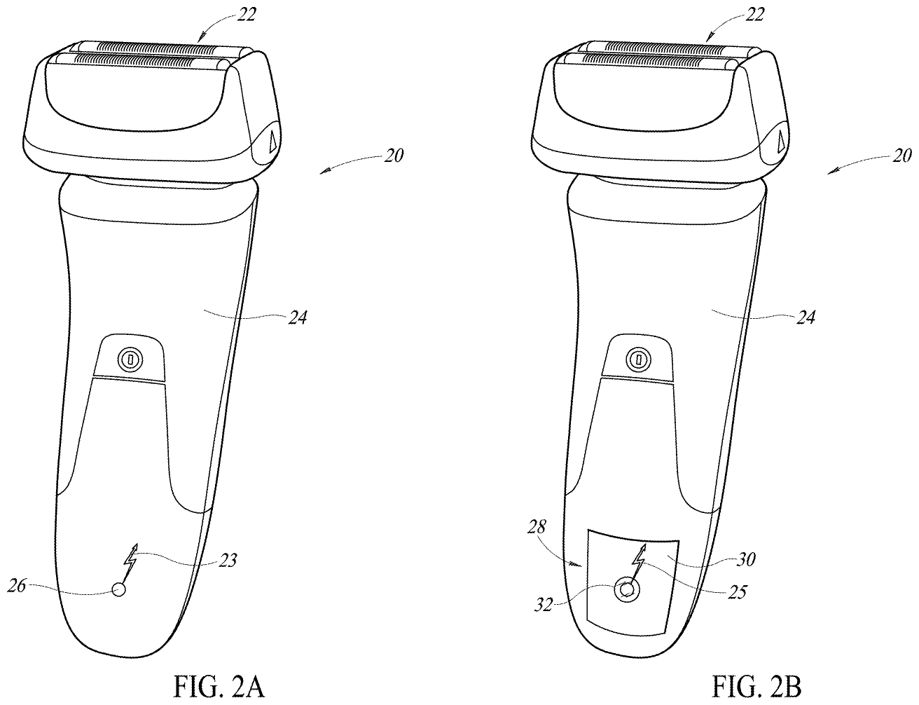

The photon converting material 18 in the embodiment of FIG. 2B can be considered a passive photon wavelength converting material because it does not use electricity to generate light from a separate LED that outputs a new wavelength of light. Rather, the material 18 absorbs the light from the first LED and makes use of that energy to cause light of a different wavelength to be emitted from the material present in the layer 18.

Photon converting materials of the passive type as standalone structures are known in the art. For example, see the upconverting molecular system described in an article titled: Supporting Information: Heavy-Atom-Free Red-to-Yellow Photon Upconversion in a Thiosquaraine Composite, by Pristash et al. of the University of Washington published here: https://pubs.acs.org/doi/10.1021/acsaem.9b01808, describing a material that outputs yellow light from received red light. See also an article titled: Green-to-blue Triplet Fusion Upconversion Sensitized by Anisotropic CdSe Nanoplatelets, by VanOrman et al. of Florida State University, published here: https://pubs.acs.org/doi/abs/10.1021/acs.chemmater.0c01354. Since the details of the structure and operation of passive photon converting materials are known in the art as shown by these publications, any chemical reactions or fluorescent response which may happen in such materials will not be described in detail herein. The current published literature, some of which is cited above, can be referred to for the operation of such structures.

The photon converting material, as disclosed and used herein, is not a light filter. A light filter operates to remove certain colors of light, namely certain wavelengths from the spectrum which passes through the filter. If the only light color shown is red, and a red filter is present, then no color will be output by the filter. The present material, on the other hand, is a photon converting material which receives red photons and then generates as an output photons of a different wavelength, whether yellow, orange, blue, or some other color. Thus, the photon converting material will output a light which is a different color from the light that impinges thereon, rather than merely filtering out an undesired color.

FIG. 2A illustrates an appliance 20 in the form of an electric razor. The electric razor has a shaved head 22 which is powered by a motor inside of a housing 24. The appliance 20 includes a light indicator 26 whose color of light 23 indicates the state of operation, or in some instances the state of the battery charged in the appliance 20. If the appliance 20 is operating properly, the light indicator 26 output may be a green or some shade of green. For some appliances, proper operation may be a red light 23. Alternatively, the light indicator 26 may indicate the charge state of a battery-powered appliance 20. In the example in which the appliance 20 is an electric razor, when the light indicator 26 is outputting green, this indicates there is sufficient charge for it to continue operating for some period of time. When the light output changes to a flashing red or green, this can indicate that the charge is decreasing or increasing, respectively. When the color of light 23 output at light indicator 26 changes to red, this can indicate that the appliance is no longer operating and needs maintenance, repair, or in some instances, can indicate that the battery needs to be charged.

The term “appliance” is used herein in the broadest sense to include any consumer product. Thus, the term includes wristwatches, smart watches, cameras, battery chargers, electric razors, smart phones, dishwashers, clothes washers and other products used by consumers.

FIG. 2B shows a corrective photon converting material 32 over the light 26 of the electric razor as the appliance 20. If the user of the appliance 20 has some range of colorblindness, they may not be able to distinguish between a green or red which is output by the light indicator 26. Accordingly, a photon converting tab 28 is provided having a holding material 30 and a photon wavelength converting material 32. The holding material 30 fixes the photon converting material 32 in a stable position on the electric razor. The tab 28 may have an adhesive on one side so that it can be applied to the appliance 20 having the photon converting lens positioned directly over the light indicator 26. The light 25 that comes out of the lens 32 will be of a different wavelength than light 23 that comes out of the LED indicator. It will be a wavelength that a color blind person can distinguish as corresponding to either red or green, for example, it might be a yellow, orange, blue or violet.

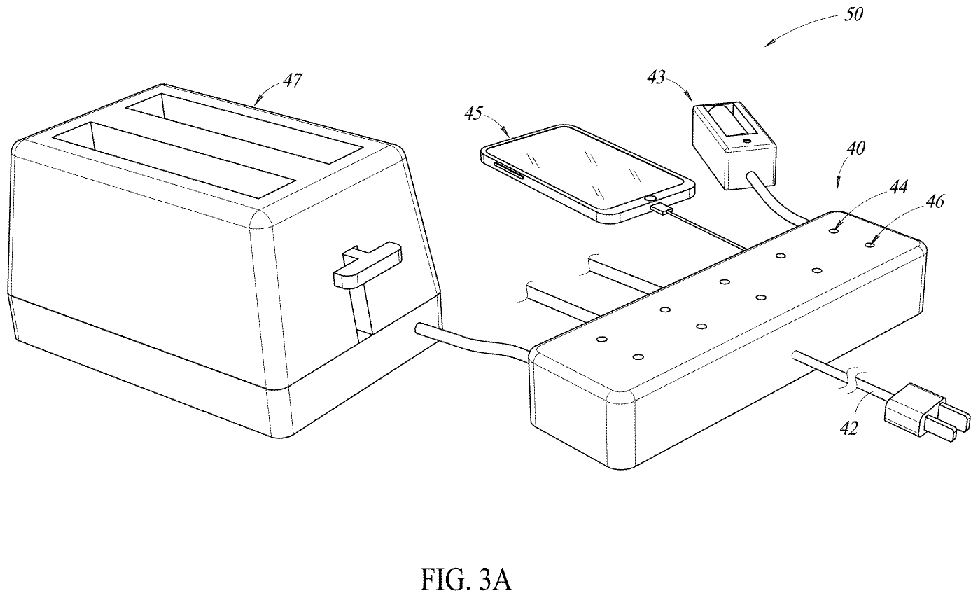

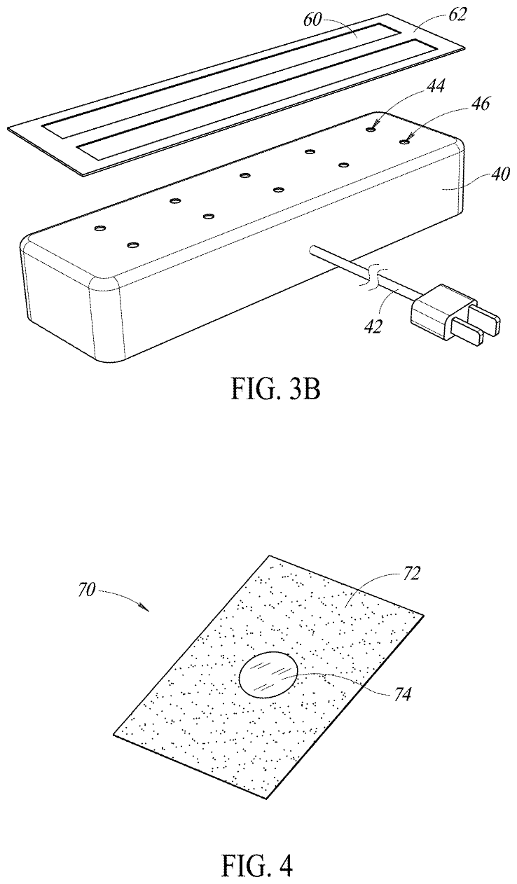

FIG. 3A indicates a large power supply 40. The power supply 40 has an output cord 42 which can be coupled to a wall socket or the grid. The power supply 40 may have a first column of lights 44 and a second column of lights 46. These lights can indicate the operational state of the power supply 40. In one embodiment, each light in the column of lights 44 can be either a red light or a green light. In another embodiment, each light in the column of lights 44 can output a variety of different colors: red, orange, yellow, green, blue, or different colors. In another embodiment, cach light in the column of lights 46 can output a single color depending on the operational state of the power supply 40, for example, green, or red, or blue, or it can work in tandem with light 44 that is in the same row of lights. In particular, the two lights 44 and 46 can be used to indicate a combination of different operational states of the power supply 40. If both lights are green, this can provide some indication of the operational state. If one light is red and the other light is green, this can indicate that the power supply is operating but that the appliance is not being charged. If both lights are red, this can provide a different indication regarding the charge state of the appliance.

The power supply 40 can provide power to any one of a number of different appliances 50. For example, the power supply 40 can provide power to a battery charger 43, a smartphone 45, a toaster 47, or any other number of different appliances. Thus, the output power can be used to charge a battery or to run an active device, such as a toaster 47.

In the embodiment in which the power supply 40 is being used to run an appliance on an active basis, such as a toaster 47, the color indication of lights 44 and 46 on the row associated with that power output can provide an indication of the operational state of that appliance 50. For example, if both of the lights in columns 44 and 46 are green this can indicate that respective appliances are drawing power and operating properly. If one of the indicators turns red, depending on the indicator this can indicate that power is being provided but that there is some improper operation going on in the appliance 50. Alternatively, it can indicate that some power is being provided but not sufficient for operation. Alternatively, the light combination can indicate that power is being requested but that sufficient power is not being provided depending on the color of the first lights in that particular row with a red, or green, or some other color.

FIG. 3B illustrates a photon converting material 60 that is held in a carrier 62 that is placed overlying the power supply 40. The material 60 is held in the carrier 62 along the entire column of the respective column of lights 44 and 46. This material 60 has the same properties as previously described, namely that a red light will appear orange or yellow when shining through it, and a green light will appear blue, purple, or some other color which can easily be distinguished from red. Importantly, the material provided will output different colors depending on the input color so the user can distinguish between them. For example, it is permissible that the photon converting material 60 convert only the red to a yellow and leave green as the same color which is being viewed through it, and thus, the user can now distinguish between yellow and green. Alternatively, the photon converting material 60 can output the same wavelength of red if that is the wavelength input, but for green outputs a blue wavelength. Therefore, the user can now distinguish between the red and the green because the green appears blue to the user. Thus, one of the colors can be left unchanged if desired. Alternatively, the photon converting material 60 can change both the red and the green two different wavelengths so that the viewer can separately distinguish them as standalone colors.

FIG. 4 shows a holder 70 having an adhesive backing 72 with a photon converting material 74 fixed therein. The adhesive material 72 on one side of the carrier 70 permits the carrier 70 to be applied to any location on the appliance, whether a wristwatch, a battery charger or other appliance so that the user can more easily distinguish the color that is being output by the appliance. All of the color viewed through the photon converting material 74 will be modified based on the type of photon converting material provided. It may be a type of material which makes no change in incoming photons of orange, yellow, green, and blue, and changes only the output of red photons to a yellow color. Alternatively, it can convert a green incoming photon to a blue photon outgoing photon, but not change other colors. The area opposite the adhesive 72 can be a solar cell to receive light and convert it to power, as described with respect to FIGS. 6A and 6B, herein.

The carrier 70 can be of any appropriate size for the appliance for which it is to be used. For example, the carrier 70 can be of a size to be put on an electric razor as shown in FIG. 2A, or can be of a size to be placed on a wristwatch, or some other appliance. The converting material 74 can therefor be the size of the face of watch and the carrier 70 can be slightly larger, sufficient to attach it to the watch.

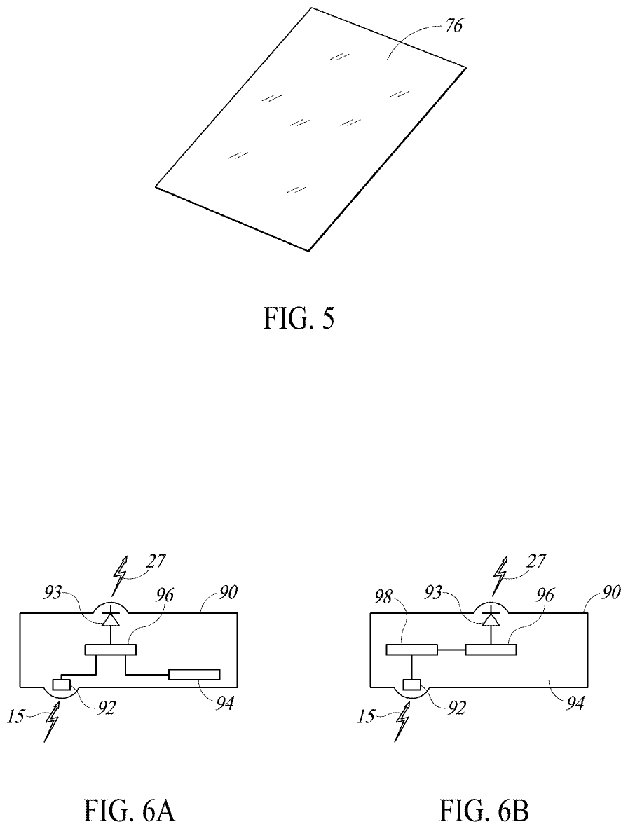

FIG. 5 illustrates a sheet 76 of a mesh material in which the entire material contains photon converting compounds. The sheet 76 of FIG. 5 may therefore be translucent, or in some instances opaque when it is not receiving light. However, when light impinges on one side of the sheet 76, the other side of the sheet outputs photons of a particular wavelength. For example, if the photons impinging on one side of the sheet 76 have a wavelength in the red or in the infrared spectrum, then the other side can output light having wavelengths in the yellow wavelength of the spectrum. It can permit other color of lights, such as orange, green, blue, or violet to pass through without changing the wavelength.

In the embodiment of FIG. 5 in which the entire sheet 76 is a photon converting material, it may be placed at the appropriate location to assist the colorblind person in understanding the color of light being output by any particular light source. It can also be cut into smaller pieces using a knife, scissors or other implement so that the user can apply the photon converting material to different uses.

The photon converting materials of FIGS. 1B, 2B, 3B, 4 and 5 can each be considered a passive photon wavelength converting material because they do not use electricity to generate light from a separate LED that outputs a new wavelength of light. Rather, the material in each of these embodiments absorbs the light from the outputting LED and makes use of that energy to cause light of a different wavelength to be emitted from the material present in the layer 18. Each of the materials 18, 28, 30, 62 and 70 can be called substrates that hold or otherwise support and retain the color converting material.

FIGS. 6A and 6B illustrate an active photon wavelength converting structure 90.

In FIG. 6A, the structure 90 includes a photon sensor 92, a logic circuit 96, a power source 94 and LED 93. The power source 94 provides the electric power on line 91 to drive the logic circuit 96, LED 93 and photon sensor 92.

The photon sensor 92 senses the light 15 as it comes from the light source of an appliance. Usually, the light 15 will be generated by a particular color from an LED, but this is not required. In one embodiment, the photon sensor 92 outputs a signal on line 95 only when the light 15 is within a selected wavelength range of a selected color. For example, if light 15 is in the red wavelength range, generally considered 625-700 nm (or 620 up to 740 or 780 nm), then the photon sensor 92 outputs a signal indicating that red light has been sensed. In one embodiment, the photon sensor 92 is selective to respond to just one color of light. As another example, if the light is in the green wavelength, 500 nm to 565 nm. (or 490 nm to 570 nm) the photon sensor 92 outputs signal on line 95, but does not output a signal if light outside of the green wavelength is sensed. There can be two sensors 92 side by side, one for red and one for green. Each will output a signal if the color sensed for is received. Thus, if other wave lengths of light impinge thereon other than the one for which that particular photon sensor 92 is sensing for, it does not output a signal on line 95. As can be appreciated, the sensors 92 can be selected to respond to light over a wide or narrow range of wavelengths. In addition, the wavelengths that are considered a selected color may vary depending on the source and the sensors 92 can be selected with such variations in mind.

In another embodiment, the sensor 92 is of the type that outputs a signal when any visible light of any wavelength is sensed.

The signal output on line 95 is sensed by logic circuit 96. The logic circuit 96 can be a very simple logic circuit, comprised of just a few logic elements and in some instances, only a few dozen transistors and few or no capacitors. Logic circuit 96 includes an LED output driver circuit, which, in its simplest embodiment is one or two transistors, which output a drive signal to turn on LED 93. The LED 93 is selected to output a light that a color blind person can distinguish as being different from red or green. As noted, most color blind people can distinguish several hues of yellow from each other and from red and green and can also distinguish several hues of blues, indigo and violet from each other and as being different from the various hues of yellow, yellow/orange, red and green. The LED 93 is selected to output a color that color blind people can distinguish as being representative of the input light 15 color that was a red or green. For example, the LED 93 can output as yellow light 27 if the sensed light 15 is red in color and can output blue (or indigo or violet) if the sensed light 15 is green in color. Thus, the wave converting structure 90 can have two sensors 92, one for red and one for green and can have two LED's 93, one to represent red, such as yellow or orange, and one to represent green, such as blue, indigo or violet.

In a preferred embodiment, one or both of the light sensors 92 and the output LED 93 or LEDs 93 are integrated in the same circuit and in some instances are on the same substrate as the logic circuit 96. The sensor 92 and LED 93, whether one of each or two of each, can be considered as logic circuit elements and be fully a part of the circuit 96 with the signal line 95 being internal to the logic circuit 96. Or, they can each be individual components.

In one embodiment, there are two photon sensors 92 adjacent to each other, one that senses red light and one that senses green light. Each of them has signal line 95 going to the logic circuit 96. There are also two light output LED's adjacent to each other, one outputting a hue of yellow light and the other outputting hue in the range of blue or indigo or violet. If the sensed light 15 is red, then the yellow LED 93 is driven to output light, but if the sensed light 15 is green, then that other LED 93 that outputs a hue in the range of blue/indigo/violet is driven to output light. While only one each of the sensors 92 and LED 93 are shown in FIGS. 6A and 6B, in some embodiments, there will be two, three, or four of each. Alternatively, a single sensor 92 can be sensitive to two or more different colors of light and out a different signal on line 95 depending on the light color. Further, the LED 93 can be capable of outputting two or more different colors of lights, depending on the signal received from the logic circuit 96.

The structure 90 can be applied to the housing 24 of the electric razor that has just one light source 26. If the light 26 of razor outputs a red color, then the structure 90 will output a yellow color that the user can recognize as being equivalent in meaning to a red color. If the same light source 26 outputs a green color, then the structure 90 will output a blue/indigo/violet color that the user recognize as being different from yellow and as being equivalent in meaning to a green color. Thus, the structure 90 can be applied to the razor in exactly the same way as the photon converting tab 28 and operate to output a different color that a color blind person can distinguish from each other and as corresponding to red or green that is output by the appliance 20.

The power source 94 can be a small battery, a solar cell, a capacitor, combination of a solar cell and a capacitor, a power line from the appliance or other source of electric power. For example, the power source 94 might be from the battery of the appliance. As another example, it might be a dedicated separate battery that is part of the structure 90.

The structure 90 is relatively thin and light weight. In a preferred embodiment, is it equal to or thinner than a standard sheet of paper. It can, for example by in the range of 0.01 to 0.1 mm in thickness. It might also range from 0.001 to 0.001 mm, or if thicker, be in the range of 0.1 to 1.5 mm. Very thin power sources are known, such as thin flexible solar cells, thin flexible capacitors, thin flexible batteries, each of them either alone or coupled to a thin battery, solar cell or other power supply. In addition, logic circuits can be very thin, as can be LEDs and photon sensors, with thickness in the range of microns or thinner. Thus, the entire structure 90 can have the thickness of equal to or less than a standard sheet of printing paper. The structure 90 can therefore be termed a substrate and can correspond to any one of the material 18, the tab 28, the carrier 62, the carrier 70 or other substrate to be applied to cover an LED that is outputting light on an appliance.

The structure of FIG. 6B has corresponding or similar to the structure of FIG. 6A except that power generator logic 98 is present instead of power source 94. The power generator logic 98 creates electric power from the energy of the input light 15 or other wireless source. Namely, it generates electric power from wireless power provided externally, such as from the light 15 or from other blue tooth, NFC, Wi-Fi, RFID or other wireless source. Circuits that generate power from a wireless or light signal are known in the art, these include circuits with inductors, capacitors, integrators of power and the like. For example, RFID logic circuits and cards are very thin and do not have an on-board power supply. When a wireless RFID signal is received, the RFID circuit will use part of that signal to generate power to run its own logic circuit. In a similar fashion, the power generator logic 98 will receive the power from the light source 15, or other wireless source, and use some of this power to generate the electricity to run the sensor 92, the logic circuit 96 and to drive the LED 93. In the embodiment of FIG. 6B, all of the power to drive the entire structure is generated in the logic 98 from one or more different wireless sources. Thus, no power supply 94 is present.

The inventors have recognized that the structure 90 does not need an instantaneous response to the changes in the light 15 being turned on and becoming present. Thus, the structure 90 can take a few moments, in some instances, a few seconds or even a few minutes to generate sufficient power in the circuit 98 to run the logic 96 and to drive the LED 93. Many appliances will have the red or green light on for extended periods of time, for example, the either the red or green light might be on at all times. In such instances, the sensor 92 is always receiving light and provides that energy to the power generator 98. The power generator can include a combination of one or more inductors, capacitors, power accumulators, integrates and the like to slowly receive, build up, accumulate and store power. Over time as the light 15 continues to be received, whether, fractions of a second, a few seconds, or a minute, the power generator will accumulate enough energy to start to run the logic circuit 96. Then, once the circuit 96 has sufficient power to operate, it can sense the signal on line 97 to determine whether light 15 is currently present. If it is present, circuit 96 can send a signal to activate LED 96 to output light 27. Thus, the power to drive structure 90 can be slowly received, built up and stored until there is a sufficient power present to run the entire structure 90. Modern electronics can run on very low power and very low voltages. Accordingly, sufficient power can be obtained, particularly if the light source 15 is constant, after a few moments, to provide the power to run the entire structure 90, including the power to drive the LED 93 to output light 27.

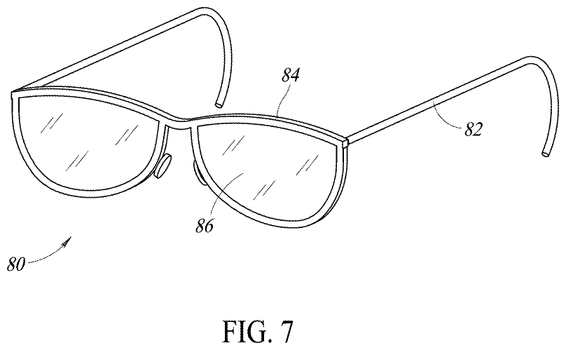

FIG. 7 illustrates a pair of eyeglasses 80 which include a frame 84 having car pieces 82. A photon converting material 86 is positioned as a lens held in the frame 84. The eyeglasses 80 can be worn by a user who is colorblind. The photon converting material 86, which fills the entire length of the eyeglasses 80 will therefore permit the user to distinguish different colors by wearing the eyeglasses. Specifically, the wavelength material 86 may be of a type which receives photons in the red wavelength part of the spectrum and outputs photons in the yellow or orange wavelength part of the spectrum which can more easily be distinguished from green by a colorblind person.

A person who has red-green colorblindness might have trouble distinguishing between red and green lights while driving, or different other lights that may be present in their local environment. The photon converting material 86 present in the lens of the eyeglasses 80 can therefore assist the wearer to more easily distinguish different colors of lights, for example to distinguish green from red, or green from blue, or red from green, or other combinations of colors.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
an appliance;
a light output source positioned on the appliance that outputs a first color of light that is hard for people with color blindness to distinguish from other colors; and
a photon converting material overlying the light output source of the appliance, the photon converting material being operative to convert the first color of the light emitted by the light output source from the first color to a second, different color of different wavelength that is more distinguishable for people with color blindness than the first color.

2. The system in claim 1, in which the photon converting material is any one of a dye, nanoparticle, fluorescent compound or another material which can upconvert photon wavelengths.

3. The system in claim 1, in which the photon converting material is embedded into a carrier material, in which the photon converting material absorbs photons of a first longer wavelength, and emits photons of a second shorter wavelength.

4. The system in claim 3, in which the carrier material may be a tape, a polymer, or other plastic, which can hold and contain the upconverting means intact, and isolate it from environmental damage.

5. The system in claim 4, in which the carrier material has an adhesive layer allowing it to be removably attached over an indicator LED of interest.

6. The system of claim 1 wherein the appliance is an electric razor.

7. The system of claim 1 wherein the appliance is a battery charger.

8. The system of claim 1 wherein the photon converting material includes a light sensor and an LED that outputs a different color of light from that received by the light sensor overlying the light output source of the appliance.

9. A light color converting system, comprising:
a substrate;
a photon receiving material positioned in the substrate, the photon receiving material configured to be positioned to receive a photon of light of a first color;
a photon color converting assembly adjacent to the photon receiving material, the photon color converting material being operative to convert the color of the received photon of light from the first color to a second, different color of a different wavelength.

10. The system in claim 9, wherein the first color is a color that is hard for color blind people to distinguish from other colors and the second color is more distinguishable for people with color blindness than the first color.

11. The system in claim 9, in which the photon converting assembly is material embedded into a substrate, in which the photon converting material absorbs photons of a first longer wavelength, and emits photons of a second shorter wavelength.

12. The system in claim 9, in which the photon converting assembly is an active assembly.

13. The system in claim 12, in which the photon converting assembly includes a photo sensor and an LED.

14. The system in claim 13, in which the photon converting assembly includes an electric power source.

15. The system in claim 14, in which the electric power source includes a battery.

16. The system in claim 14, in which the electric power source includes a power generator that produces electric power from electromagnetic radiation.

17. The system of claim 14 wherein the electromagnetic radiation is light.

18. The system of claim 14 wherein the electromagnetic radiation is a radio frequency wave.

19. The system in claim 9, in which the photon converting assembly is a passive assembly.
